(19) United States
(12) Patent Application Publication
(10) Pub. No.: US 2013/0318845 A1
(43) Pub. Date: Dec. 5, 2013

(54) SIGNAGE STRUCTURES

(71) Applicant: Bonnye Virginia Bartosh, Hamilton (NZ)

(72) Inventor: Bonnye Virginia Bartosh, Hamilton (NZ)

(21) Appl. No.: 13/985,769

(22) PCT Filed: Feb. 15, 2012
(86) PCT No.: PCT/NZ12/00018

§ 371 Date: Aug. 15, 2013

(30) Foreign Application Priority Data
Feb. 15, 2011 (NZ) 591151

(51) Int. Cl. G09F 15/00

(52) U.S. Cl. CPC G09F 15/0062
USPC 40/610; 29/401.1

(57) ABSTRACT

A portable signage structure is provided and includes a first panel, and a second panel, wherein each panel has an upper edge, a bottom edge, and side edges extending between the upper and bottom edges, and wherein the panels include a resilient frame about their edges, and wherein the panels have a common upper edge. The structure also includes a pair of resilient linking frames extending between opposing bottom edges of the panels and along at least a portion of the opposing side edges of the panels. The linking frames help to enable the signage structure to be quickly and easily erected. The structure is particularly suitable as a portable scoreboard, but may also be applicable to advertising and the like. A method of erecting and collapsing the signage structure is also provided.

### TECHNICAL FIELD

The present invention relates to improvements in signage structures. The invention has particular application to “pop-up” signage structures such as portable scoreboards.

### BACKGROUND ART

Portable signs are often used in school, club or amateur sports to indicate particulars of a game in progress. Such particulars might include scores of teams, points by specific players, remaining game time, and so on.

Such signs tend to be bulky and cumbersome apparatus which needs to be transported from location to location as required. The apparatus also tends to be weighty, and this is a particular problem when a vehicle cannot be used to transport the sign to the area where it is required, as is often the case when the sign is to be used on a sports field.

Many of these structures also require a number of components in order to assemble and hold the sign together. Therefore, it is important that no critical parts required for the assembly of the sign are lost.

An example of such a sign is the scoreboard disclosed in U.S. Pat. No. 5,615,636.

This patent discloses a scoreboard assembled from several lengths of tubing, all of which needs to be carried to where the scoreboard is to be erected. The base tubes then need to be inserted into the ground in order to stabilise the scoreboard.

Cards carrying numbers or other identifying characteristics are hung on hooks suspended from the horizontal lengths of tubing to represent the score of a game in progress. However, these cards are easily affected by the wind, and it may be difficult for participants and spectators alike to determine the score of a game in progress.

Another example of a portable scoreboard is disclosed in U.S. Pat. No. 5,620,099.

The patent specification describes a portable scoreboard that includes an integrated storage and carrier unit, the intention being to provide a scoreboard that is easily stored.

However, to ensure the scoreboard is a suitable size for the carrier unit, the indicia carried by the board is limited in its size. Thus, the indicia showing, for example, the score of the sports game in progress, may not be readily apparent to spectators and participants unless the viewer is quite close to the board.

A further example of a portable scoreboard is disclosed in U.S. Pat. No. 7,117,619. This apparatus is a banner, on which scoring symbols or indicia may be placed while a game is in progress.

In this instance, the banner requires a supporting structure for mounting and ensuring the banner is readily visible. This supporting structure may be a fence, which is not always present on a sports field, or dedicated poles or the like, which is additional equipment which must be carried by the individual or individuals responsible for score keeping.

There is still a need for a readily portable scoreboard that is easily erected and has a minimum number of components. It is an object of the present invention to address the foregoing problems or at least to provide the public with a useful choice.

Further aspects and advantages of the present invention will become apparent from the ensuing description which is given by way of example only.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

### DISCLOSURE OF THE INVENTION

According to one aspect of the present invention there is provided a signage structure, the structure including

a first panel, and

a second panel, wherein each panel has an upper edge, a bottom edge, and side edges extending between the upper and bottom edges, and wherein the panels include a resilient frame about their edges, and wherein the panels have a common upper edge,

characterised in that

the structure includes a pair of resilient linking frames extending between opposing bottom edges of the panels and along at least a portion of the opposing side edges of the panels.

According to one aspect of the present invention there is provided indicia for a signage structure, wherein the structure includes a first panel, and a second panel, wherein each panel has an upper edge, a bottom edge, and side edges extending between the upper and bottom edges, and wherein the panels include a resilient frame about their edges, and wherein the panels have a common upper edge, wherein the structure includes a pair of resilient linking frames extending between opposing bottom edges of the panels and along at least a portion of the opposing side edges of the panels, and wherein the panels include an means for attaching indicia, the indicia characterised in that the indicia includes attachment means complementary to that of the panel.

According to another aspect of the present invention, there is provided a method of collapsing a signage structure, wherein the structure includes a first panel, and a second panel, wherein each panel has an upper edge, a bottom edge, and side edges extending between the upper and bottom edges, and wherein the panels include a resilient frame about their edges, and wherein the panels have a common upper edge, characterised in that the structure includes a pair of resilient linking frames extending between the opposing bottom edges of the panels and along at least a portion of the opposing side edges of the panels, the method including the steps of.
a) collapsing the signage structure such that the first and second panels lay on top of one another; and
b) folding the first and second panels by twisting the panels into a figure of eight and;
c) folding the panel halves on top of one another.

According to another aspect of the present invention, there is provided a method of erecting a signage structure, wherein the structure includes a first panel, and a second panel, wherein each panel has an upper edge, a bottom edge, and side edges extending between the upper and bottom edges, and wherein the panels include a resilient frame about their edges, and wherein the panels have a common upper edge, characterised in that the structure includes a pair of resilient linking frames extending between the opposing bottom edges of the panels and along at least a portion of the opposing side edges of the panels, the method including the steps of:
a) opening the signage structure such that the resilient frames of the first and second panels “pop” open; and
b) placing the bottom edges of the panels on the ground; and
c) temporarily securing the structure to the ground.

The present invention is a signage structure which is readily erected upon opening, and is easily collapsible by twisting the panels and folding them onto themselves. Such a structure may be considered to be a “pop-up” structure. The invention has particular application to portable scoreboards, such as those used in amateur, recreational, club and school sports.

A person skilled in the art will appreciate that although reference is made throughout the specification to the signage structure being a portable scoreboard, the present invention has application to general signage structures such as those used by persons undertaking cleaning and/or maintenance work.

The present invention may also be readily applicable to merchandising signage, billboards or the like.

The present invention includes at least two panels, with each panel having at least three sides, and in preferred embodiments of the present invention, four sides. The panels should be understood to be fabricated from fabric or textiles such that the panels are flexible.

The two panels are joined along one edge, which may be thought of as the upper edge. It will be appreciated that this means each panel has an outer face, which faces outwards and is the face of the panel readily visible to spectators and players, and an inner face which substantially faces the opposing panel.

Persons skilled in the art will appreciate that the present invention may have triangular panels and in such embodiments, the upper edge may be the intersection of the peaks of the panels.

In some embodiments of the present invention, the panels may be permanently joined to each other along their upper edges via stitching, gluing or otherwise securing the panels.

In preferred embodiments of the present invention, the panels are joined at their upper edges through the use of hook and loop material such as Velcro™. Button, stud or other fasteners readily apparent to persons skilled in the art may also be used.

In preferred embodiments of the present invention, reinforcing strapping material may be used to further strengthen the temporary connection of the panels along their edges. Such strapping may run from the outer face of the first panel, over the upper edge, and onto the outer face of the second panel. The strapping material may be nylon straps which engage with fastening loops positioned on the panel faces or could be additional hook and loop material.

The panels are provided with a bottom edge. It should be understood that the lower edge of the panel sits upon the ground over which the present invention is to be erected. It will be appreciated that in a side view, the panels, when “popped” up approximate a triangular-shaped profile, with the peak of the triangle being the common upper edges of the panels and the bottom edges forming the base of each arm.

In preferred embodiments of the present invention, the panels are substantially square or rectangular panels, with opposing parallel sides.

Each panel is provided with a resilient frame about its sides to form the perimeter of the panel.

Preferably, the resilient frame is in the form of flat spring wire made from steel or a similar material.

The inventor has a preference for steel wire of 2 mm thickness and 6 mm width. This provides the necessary spring tension to ensure the scoreboard readily “pops” up, but also provides the necessary rigidity once erected such that it is not easily distorted by windy conditions. Essentially, the use of flat spring wire ensures that the panel holds its shape once it is erected, but without compromising the ability to collapse the panel as needed.

There may be variations in the thickness and width of the steel wire that is used in the present invention, depending on the material that is used for the panels. A lighter material may allow for thinner and narrower wire, while heavier material, such as canvas, may need thicker wire to ensure there is enough inherent tension and strength in the wire to support the panels and ensure they “pop” up.

However, the use of flat spring steel wire is not meant to be limiting. Other metals, metal alloys or materials such as plastics material may be used, so long as the material is readily folded or otherwise deformed while retaining sufficient material memory or resiliency to return to its original shape. It also needs to have sufficient tension to “pop” up as required even after prolonged and repeated use.

In preferred embodiments of the present invention, each panel may be provided with a sleeve, webbing or a similar structure about its perimeter, with the sleeve housing the resilient frame.

In preferred embodiments of the present invention, the sleeve is fabricated from hard wearing synthetic textiles such as nylon.

Persons skilled in the art will appreciate that the sleeve is readily formed by folding the edge of the material upon itself to form a tube. The sleeve can then be stitched or otherwise secured to the panels. Of course, this is not meant to be limiting and other methods for housing the resilient frame and securing it to the panel are envisaged.

The sleeve may be located on the margins of either the inner or outer face of the panels. Alternatively, one edge of the material from which the sleeve is to be fabricated is affixed to the outer face of the panel with the other edge affixed to the inner face of the panel, thus forming a tube in which the frame may be inserted.

Alternatively, the panel may be provided with clasps or the like which temporarily secure the resilient frame. However, the inventor designed the present invention with simplicity in manufacture and ease of use in mind. Additional fastening mechanisms such as clasps to secure the frame to the panels are not preferred for this reason.

The panels may be fabricated from any suitable fabric or textiles, such as canvas, polyester, acrylic, nylon or the like.

For weight reasons, the inventor preferred to use synthetic mesh. Using lightweight mesh keeps the overall weight of the signage structure to a minimum. This also allows a breeze or wind to pass through the structure when it is erected without adversely affecting the surface area of the signage structure.

In some embodiments of the present invention, each panel is formed from two layers of material, the first layer or outward facing layer being mesh, with the second layer being sheet material which provides some contrast to the mesh, allowing any indicia displayed to be more easily seen against the mesh.

Preferably, the synthetic mesh is UV resistant. This is an important consideration when the invention is to be exposed to sunlight, particularly for summer sports such as cricket. Prolonged sunlight, and thus UV rays, can lead to the degradation of many synthetic materials unless they are UV resistant.

In preferred embodiments of the present invention, the outer face of at least one panel includes an attachment region to which indicia may be temporarily affixed to the panels.

In some embodiments of the present invention, the outer faces of both panels may be provided with an attachment region, meaning both sides of the scoreboard may be used. This can be useful when the scoreboard is positioned between two playing fields, as the board can used to score games in progress on both fields.

The indicia may be cards or the like which bear numbers (to represent scores or times) or other sporting indicia such as player or team names. Alternatively, the cards may be formed in the shape of particular numbers.

Persons skilled in the art will appreciate that other possibilities are envisaged for presenting information to the spectators, officials and players.

Preferably, the attachment region includes attachment material such as hook and loop material. An example of such a material is Velcro™. This may be used to mount the indicia to the scoreboard temporarily, the indicia having corresponding Velcro™ material on one side. These interact with the Velcro™ on the panels in order to secure the cards to the signage structure.

However, this is not meant to be limiting and other methods for temporarily affixing indicia to the panels may be readily envisaged by a person skilled in the art. For example, low tack adhesive may be used to secure indicia temporarily to the panels.

In some embodiments of the present invention, certain indicia may be sewn or otherwise more permanently affixed to the panels. For example, a dedicated scoreboard may be provided to a particular team, and the team's name may be permanently secured to the panels.

Alternatively, scoreboards intended for use with specific sports may have particular indicia associated with that sport permanently fixed to the panels. For example, a scoreboard for cricket may have specific headings permanently sewn or otherwise fixed to the scoreboard. These headings could be “RUNS”, “WICKETS” or the like.

In preferred embodiments of the present invention, the indicia are provided with high contrast markings to maximise their visibility in use.

In some embodiments of the present invention, the indicia may include advertising associated with the sport, team or players.

In preferred embodiments of the present invention, D-rings or loops may be provided along the bottom edges and/or corners of the panels.

These loops can be used with ground pegs or the like to secure the structure to the ground.

Additional loops may be provided along the sides of each panel for use with guy ropes and ground pegs or the like to further secure the structure in the event there is a strong breeze while the scoreboard is in use.

The present invention includes resilient linking frames, which link the panels at their lower edges.

In a preferred embodiment of the present invention, the linking frames are formed from flat spring steel wire. The inventor has a preference for steel wire of 2 mm thickness and 6 mm width. This provides the necessary spring tension to ensure the scoreboard readily “pops” up, but also provides the necessary rigidity once erected such that it is not easily distorted by windy conditions.

However, the stated dimensions of the steel wire is not meant to be limiting and spring wire of other dimensions may be used depending on the materials that may be used for the panels (which affect the overall weight of the structure). Generally, the heavier the panels the stronger the wire (and therefore the thicker/wider the wire) needs to be in order to have the inherent tension required to “pop” the panels up.

Furthermore, the use of flat spring steel wire is not meant to be limiting, and other metals, metal alloys or materials such as plastics material of varying dimensions may be used, so long as the material is readily folded and has sufficient tension to “pop” up as required even after prolonged and repeated use.

As discussed above, it should be understood that when erected, the invention approximates triangular-shaped profile in a side view, with the peak of the triangle formed by the common upper edges of each panel. With the linking frames, the invention can be said to approximate a pyramid-shaped profile, with the horizontal base line of the pyramid being formed by the linking frames.

Preferably, the linking frames have a U-shaped profile, with the horizontal member of the U forming the base of the pyramid-shaped profile described above.

Preferably, the two vertical arms of the U extend at least substantially part way up the sides of the panels. In effect, the vertical arms double the rigidity of the panels due to the overlap with the frame of each panels. This is important, as it provides the present invention with rigidity to ensure that it stands upright unassisted, if necessary.

It will be appreciated by a person skilled in the art that these linking frames mimic the function of side panels, but without the limitation of the surface area that such side panels would present to a breeze or wind blowing against the scoreboard when it is erected.

Furthermore, the use of these U-shaped linking frames provide rigidity to the structure, and due to the open end of the U-shaped profile, helps ensure that a substantially triangular shaped profile (in a side view) is formed and maintained by the present invention.

In preferred embodiments of the present invention, the linking frames are encased in a sleeve, webbing or similar structure. A sleeve may be formed by any suitable material, such as nylon or the like. The sleeve may be readily formed by folding the edge of the material upon itself to form a tube, which can then be stitched or glued to the panels in the appropriate location.

A sleeve for the linking frames is preferred for packaging reasons, keeping the presentation of the scoreboard as tidy as possible. It also minimises the risk of the otherwise exposed linking frame damaging the panels through contact with the bare metal edges of the frame.

It will be appreciated by a person skilled in the art that the scoreboard as described above is largely a unitary structure. No fasteners or the like are required to join the various frame and panel members together.

In some embodiments of the present invention, the structure may optionally be provided with a base panel, and skirting panels to partially enclose the lower portion of the scoreboard.

The combination of the base and skirting panels forms a recess into which a gear bag or the like may be placed, and this can assist in the weighting of the scoreboard when it is in an erect state. This is particularly useful in the event the scoreboard is used on a substrate that prohibits the use of ground pegs or the like, such as asphalt or concrete.

The base panel may be formed from a sheet of fabric or textiles such as canvas, nylon, acrylic or another suitable material that extends between the linking frames. However, it should be appreciated that the base panel is not necessarily reinforced with a resilient frame as is the case with the first and second panels.

The same may be true for the skirting panels, which may also be formed from a sheet of canvas, nylon, acrylic or another suitable material.

In some embodiments of the present invention, it will be appreciated that the outer edges of the base panel, or the lower or upper edges of the skirting panels is integrated with the linking frame, and thus these edges may include a sleeve or the like to shroud the linking frame.

The main function of the base panel and/or skirting panels is simply to form a recess within the area defined by the inner faces of the first and second panels.

However, the inventor has noted that having skirting panels may be useful in ensuring the lower portions of the panels do not overly expand due to the resilient frames in each panel. The skirting panels limit the extent to which the panels diverge away from each other.

In some embodiments of the present invention, the upper edges or the sides of the panels may be provided with handles such that the scoreboard can be easily picked up and repositioned without having to collapse the scoreboard.

In use, the scoreboard may be removed from a bag or similar carrying device as kitset with appropriate indicia cards.

Because of the resilient frame, the scoreboard can be partially unfolded, and the tension of the sprung steel frames of the panels ensures that the scoreboard will “pop” open.

If necessary, the structure can be secured to the ground using a gear bag placed in a recess formed by the skirts and base panel (if these features are present). The scoreboard may be further secured by using ground pegs, stakes or the like (which are readily sourced) through the D-rings or loops provided along the edges of the first or second panels or through the use of guy ropes.

Scoring can be carried out by applying the appropriately marked cards to the attachment region of the first and/or second panels. Because of its light weight and collapsible nature, the structure can be sized for maximum visibility without incurring a significant weight penalty.

When no longer required, the structure can simply be folded by collapsing the linking frames, twisting the main panels such that they form a shape similar to a FIG. 8, and folded upon themselves, and placed into a bag along with the indicia until required.

The cards may be carried in a separate bag, configured with suitable compartments. Alternatively, they may simply be carried in a team sports bag as required.

It will be appreciated that the present invention offers a number of advantages over the prior art, including:
readily and easily transportable; and/or
readily stored due to its compact size when collapsed; and/or
lightweight; and/or
simple to erect and collapse; and/or
minimal components required for assembly; and/or
adaptable to different kinds of sports; and/or
highly visible; and/or
relatively wind resistant when erected.

### BRIEF DESCRIPTION OF DRAWINGS

Further aspects of the present invention will become apparent from the following description which is given by way of example only and with reference to the accompanying drawings in which:

FIG. 1 is a perspective view of the present invention in use;

FIG. 2 is a side view of the present invention in use; and

FIG. 3 is a perspective view demonstrating the first part of the process of collapsing the present invention when not in use; and

FIG. 4 is a perspective view demonstrating the second part of the process of collapsing the present invention when not in use; and

FIGS. 5a-b is a perspective view demonstrating the final two parts of the process of collapsing the present invention when not in use.

### BEST MODES FOR CARRYING OUT THE INVENTION

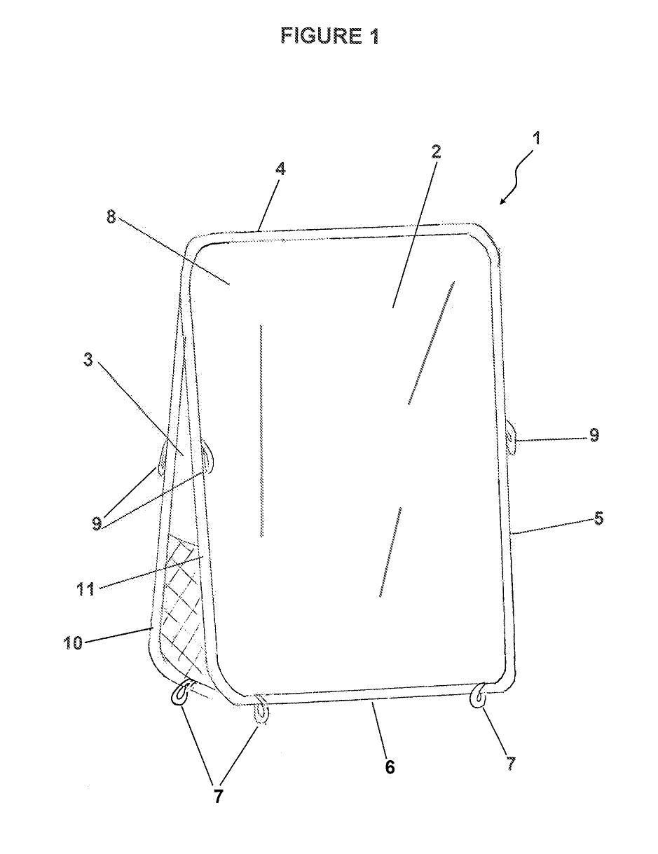

The present invention is illustrated in FIG. 1, and shows the invention (1) in the form of a portable scoreboard.

The scoreboard consists of two panels (2, 3), formed from a synthetic nylon mesh. The panels (2, 3) have a common upper edge (4).

Each panel (2, 3) is bound about its perimeter by a resilient frame in the form of sprung steel wire (not shown) encased in a sleeve (5).

Along the bottom edge (6) of each panel (2, 3) is provided loops (7) through which ground pegs may be used to secure the scoreboard to the ground.

On the outer faces (8) of each panel (only outer face of panel 2 is shown), Velcro™ is provided (not shown). This allows cards (not shown), provided with corresponding Velcro™ on their reverse faces, to be applied to the scoreboard (1) to indicate the progress of the game in play.

The panels also are provided with guy ropes (not shown). These extend from loops (9) along the side edges (10, 11) of the panels (2, 3) and further assist in the stabilising of the scoreboard (1) if required.

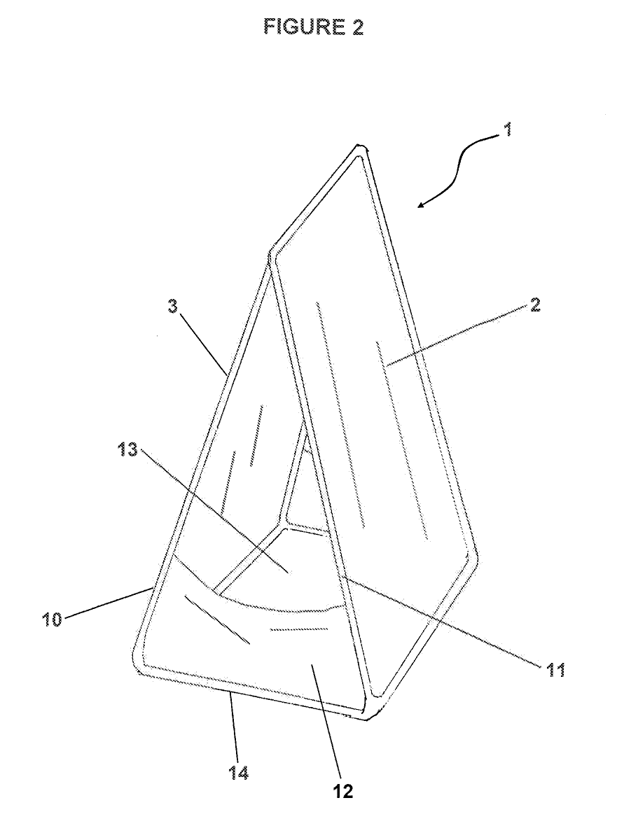

Turning now to FIG. 2, it will be appreciated that the scoreboard (1) is provided with a skirt (12). This extends between the first (2) and second panels (3), and when erected, forms a recess (13) into which a sports bag (not shown) may be placed. This may further assist in weighting of the scoreboard (1) to the ground.

The linking frame (14) is also readily apparent in this view of the invention (1). The linking frame (14) extends between the first (2) and second (3) panels, and part way up the side edges (10, 11) of the panels. This provides rigidity to the overall structure (1).

As can be appreciated from this view, the scoreboard (1), when erected, maintains an approximate triangular shape, while ensuring the board remains under sufficient tension to remain upright.

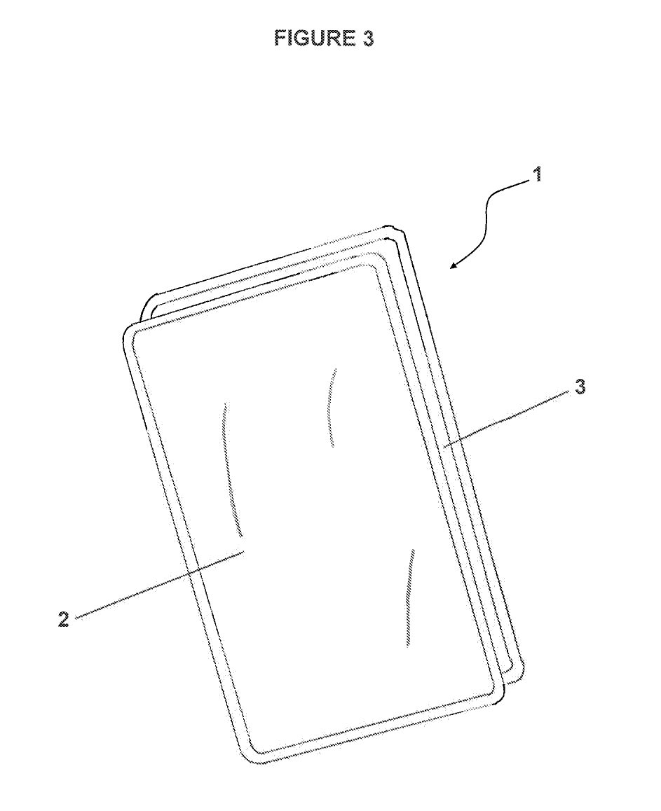

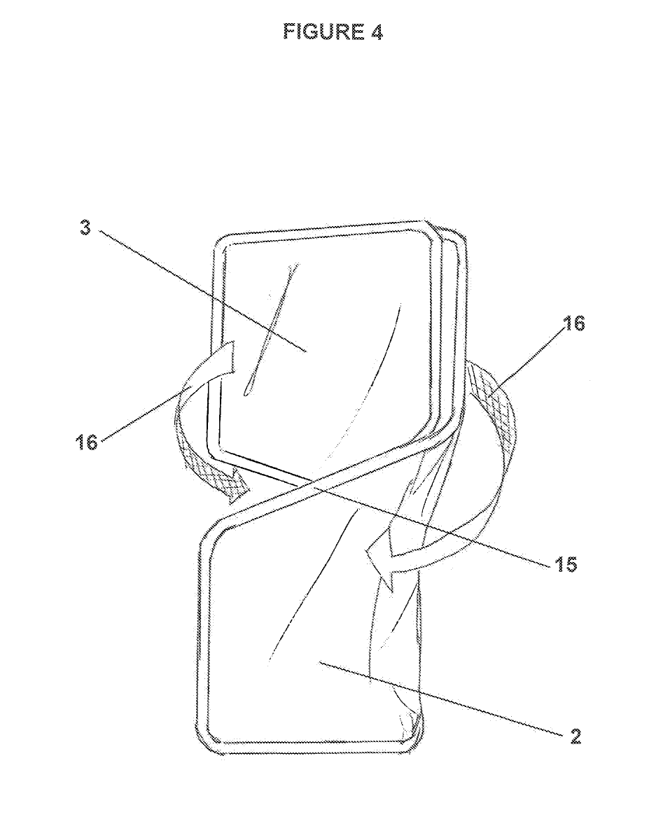

To collapse the scoreboard, as demonstrated in FIGS. 3 to 5a and 5b, the scoreboard (1) is laid flat, with indicia cards removed from the first (2) and second (3) panels. The panels (2, 3) are then twisted at their centre (15) in the direction of arrows 16 to form an approximate figure of eight, as depicted in FIG. 4.

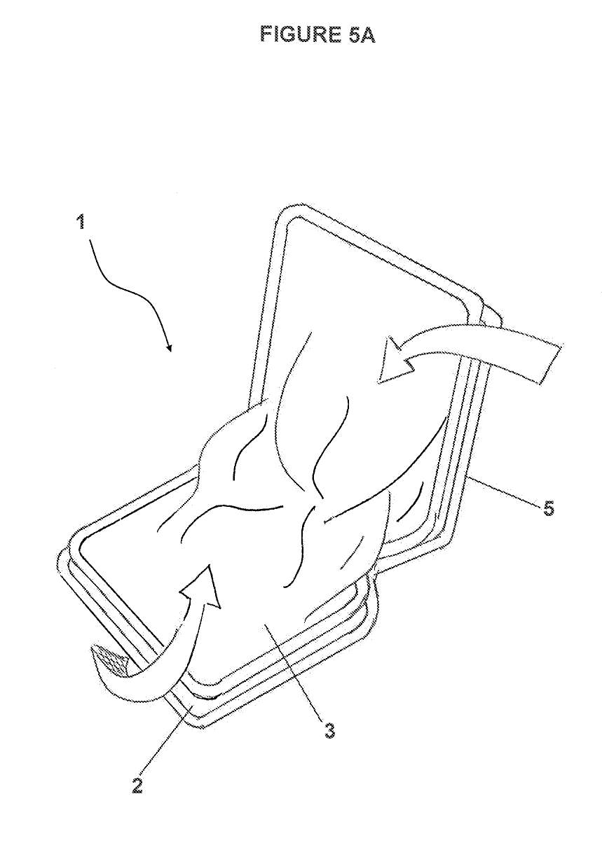

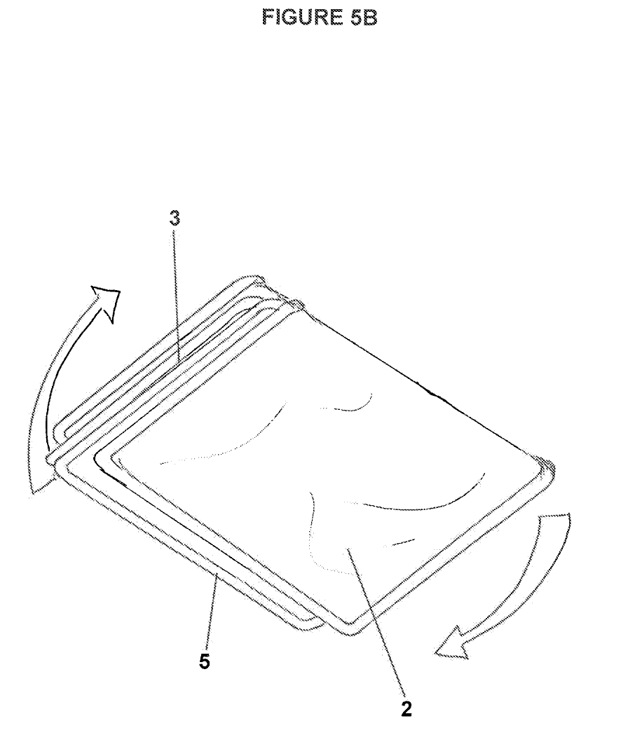

The panels (2, 3) can then be folded upon themselves as depicted in FIGS. 5a and 5b. Because of the sprung steel frame shrouded in its sleeve (5), there is an inherent tension in the scoreboard (1). One merely needs to release the folded frame (5) and it automatically “pops” up.

Aspects of the present invention have been described by way of example only and it should be appreciated that modifications and additions may be made thereto without departing from the scope thereof.

1. A signage structure, the structure comprising:
a first panel;
a second panel, wherein each said panel has an upper edge, a bottom edge, and side edges extending between the upper and bottom edges, and wherein the panels include a resilient frame about their edges, and wherein the panels have a common upper edge; and
the structure includes a pair of resilient linking frames extending between opposing bottom edges of the panels and along at least a portion of the opposing side edges of the panels.

2. The signage structure as claimed in claim 1 wherein the resilient frame of the panels is in the form of flat sprung wire.

3. The signage structure as claimed in claim 1 wherein the resilient frame is housed in a sleeve, webbing or a similar structure about the perimeter of each panel.

4. The signage structure as claimed in claim 1 wherein an outer face of at least one panel includes an attachment region to which indicia may be temporarily affixed to the panels.

5. The signage structure as claimed in claim 4 wherein the attachment region includes hook and loop material.

6. The signage structure as claimed in claim 1 wherein at least one loop is provided along the edges and/or corners of the panels.

7. The signage structure as claimed in claim 1 wherein the resilient linking frames have a U-shaped profile, with the horizontal stroke of the U extending between the opposing bottom edges of the panels.

8. The signage structure as claimed in claim 1 wherein the resilient linking frames are encased in a sleeve, webbing or similar structure.

9. The signage structure as claimed in claim 1 wherein the resilient linking frames are formed from flat sprung steel wire.

10. The signage structure as claimed in claim 1 wherein the panels are substantially square or rectangular panels.

11. The signage structure as claimed in claim 1 wherein the structure includes a base panel.

12. The signage structure as claimed in claim 1 wherein the structure includes skirting panels.

13. The signage structure as claimed in claim 12 wherein each skirting panel includes a sleeve, webbing or similar structure for the resilient linking frame.

14. The signage structure as claimed in claim 1 wherein the top or sides of the panels are configured with carry handles.

15. The signage structure as claimed in claim 1 wherein the panels are formed from synthetic fabrics or textiles.

16. Indicia for use with a signage structure, wherein the structure includes a first panel, and a second panel, wherein each panel has an upper edge, a bottom edge, and side edges extending between the upper and bottom edges, and wherein the panels include a resilient frame about their edges, and wherein the panels have a common upper edge, wherein the structure includes a pair of resilient linking frames extending between opposing bottom edges of the panels and along at least a portion of the opposing side edges of the panels, and wherein the panels include an means for attaching indicia, the indicia comprising attachment means complementary to that of the panel.

17. A kitset for a signage structure, the kitset comprising:
a signage structure, the structure including a first panel, and a second panel, wherein each panel has an upper edge, a bottom edge, and side edges extending between the upper and bottom edges, and wherein the panels include a resilient frame about their edges, and wherein the panels have a common upper edge, the structure including a pair of resilient linking frames extending between opposing bottom edges of the panels and along at least a portion of the opposing side edges of the panels; and
indicia for use with the signage structure, wherein the indicia includes attachment means complementary to that of the panels of the signage structure.

18. A method of erecting a signage structure, wherein the structure includes a first panel, and a second panel, wherein each panel has an upper edge, a bottom edge, and side edges extending between the upper and bottom edges, and wherein the panels include a resilient frame about their edges, and wherein the panels have a common upper edge, characterised in that the structure includes a pair of resilient linking frames extending between the opposing bottom edges of the panels and along at least a portion of the opposing side edges of the panels, the method including the steps of:
a) opening the signage structure such that the resilient frames of the first and second panels “pop” open; and
b) placing the bottom edges of the panels on the ground; and
c) temporarily securing the structure to the ground.

19. A method of collapsing a signage structure, wherein the structure includes a first panel, and a second panel, wherein each panel has an upper edge, a bottom edge, and side edges extending between the upper and bottom edges, and wherein the panels include a resilient frame about their edges, and wherein the panels have a common upper edge, characterised in that the structure includes a pair of resilient linking frames extending between the opposing bottom edges of the panels and along at least a portion of the opposing side edges of the panels, the method including the steps of.
a) collapsing the signage structure such that the first and second panels lay on top of one another; and
b) folding the first and second panels by twisting the panels into a figure of eight and;
c) folding the panel halves on top of one another.

20-21. (canceled)
